(19) United States
(12) Patent Application Publication
(10) Pub. No.: US 2016/0334584 A1
(43) Pub. Date: Nov. 17, 2016

(54) FIBER OPTIC CONNECTION CLEANING TOOL

(71) Applicant: James Brandon Stamps, Birmingham, AL (US)

(72) Inventor: James Brandon Stamps, Birmingham, AL (US)

(73) Assignee: RAINBOW TECHNOLOGY CORPORATION, Pelham, AL (US)

(21) Appl. No.: 14/710,338

(22) Filed: May 12, 2015

(51) Int. Cl. G02B 6/38; B08B 1/00

(52) U.S. Cl. CPC G02B 6/3866; B08B 1/003; B08B 1/006

(57) ABSTRACT

A tool for cleaning the ends of fiber optic cables at a connection of two cable ends includes a base member having a flat portion and a probe-like end to which swab of absorbent material affixed encompassing the end and suitably sized for insertion into an adaptor at a fiber optic cable connection to clean a fiber optic surface there within. A pad of absorbent material is affixed to the flat portion distal said probe-like end said pad being suitably sized and a configured for cleaning the fiber optic surface of a connector portion of a fiber optic cable connection.

### FIELD OF INVENTION

The present invention relates to cleaning devices for mechanically cleaning the end surfaces of an optical fiber. More particularly the present invention relates to a single use cleaning device for cleaning the end surfaces of optical fibers which are to be placed in abutting relationship by a conductor structure.

### BACKGROUND

In fiber optic networks, optical fiber strands are connected by encasing the strands in protective jackets to form cables and butting two cable ends together. To do this, the ends of the cable may be stripped of the jacket and bonded and encased in the center of a rod-like ceramic ferrule, thereby providing an enlarged surface area for finished polishing of the exposed end face of the optical fiber cable. The ferrules generally conform to standard sizes having end faces with diameters of 1.25 millimeters (mm), 1.6 mm, 2.0 mm or 2.5 mm. The ferrule end faces are polished. These ferrules are fitted into variations of connector housings which precisely interconnect with similar devices via a coupler or bulkhead insure the exact alignment of the butted optical fiber strands. In many connections the optical fiber connection will form a male and female connection with the end of one cable recessed in the connector and the end of the other cable exposed for insertion into the connector.

When connecting an optical connector, if a foreign material contaminates an end face, the foreign material causes damage at the time of connection and disconnection, an increase in transmission loss. Sources of such contamination include smoke, dust, dirt, moisture and other ambient contaminates; oils, salts and particles transferred from the skin of technicians during connector manufacture and assembly, cable installation, or job site service work. Small amounts of contamination in the form of particles or haze will significantly increase light attenuation across the butted connection. For this reason, it is necessary to clean the joining end face prior to the butted optical fiber connection. For cleaning of the joining end face of the optical connector, an optical connector cleaning tool that wipes away grime or the like by bringing a cleaning body such as a fabric into contact with the joining end face is used.

### SUMMARY OF THE INVENTION

A general object of the invention is to provide a disposal fiber optic cleaning tool that can be used by installation and repair personnel. Another object of the invention is to provide a disposable fiber optic tool that can provide a wet dry cleaning capability for both ends of abutting fiber optic cables. Yet another object of the invention is to provide a disposable fiber optic cleaning device that is easy to use and can be easily manipulated by a technician.

In one embodiment, the device is formed with a flat center section and two cylindrical end sections. The end sections have swabs of material attached thereto for insertion into the female portion of the fiber optic cable connection and the flat center section has similar material secured thereto to engage the male portion of the fiber optic cable connection. In this embodiment a wet/dry cleaning capability can be achieved through the packaging of the product with one end lightly coated with a wetting solvent.

In accordance with another embodiment, the base includes a flat end and a swab end. The flat end supports a wrapped cleaning material for cleaning the male end of the connection while the swab end supports swabbing material for cleaning the female end of the connection.

### BRIEF DESCRIPTION OF THE DRAWINGS

Referring to the drawings which are appended hereto and which form a portion of this disclosure, it may be seen that:

FIG. 1 is plan view of the body member of a first embodiment;

FIG. 2 is a perspective view of the first embodiment showing the swab material applied to the body:

FIG. 3 is a plan view of the body member of a second embodiment with the swab material applied thereto;

FIG. 4 is an end view of the second embodiment.

FIG. 5 is a view of a first packaging system; and,

FIG. 6 is a view of alternative packaging

FIG. 7 is a view of a third embodiment.

### DETAILED DESCRIPTION

One or more of the above objects can be achieved, at least in part, by providing a plastic or wooden disposable item that will be wrapped on both of the ends by a cotton, polyester, pulp blend of swab material. The material could be non-woven polyester cellulose blend fabric, non-woven melt blown polypropylene fabric or a knitted or woven microfiber fabric. The material need the properties of (1) softness not to scratch the end face, (2) cushioning to permit the wipe surface to conform to the end face, (3) absorbency to draw soiled solvent from the fiber optic end face and (4) inherent cleanliness to not contribute to contamination.

The same material can be used to wrap the two flat sides of the stick intermediate the ends as a cleaning surface. Instead of a single layer, the wrap may be multiple layers of single sheets to provide the necessary cushioning and absorbency. This embodiment will have four cleaning surfaces along the flat sides of the stick for the fiber end face and two swabs at the ends to clean the adapter. In one embodiment we lightly pre-saturate one end with a solvent and leave the other side dry which will provide a “wet to dry” cleaning process. A variety of solvents are contemplated to saturate the material, including alcohol, water, ketones, esters, aliphatic hydrocarbons or various blends of these solvents. It will be understood that the foregoing cleaning tools may be packaged individually or as bundles in suitable packing arrangements that protect them from their ambient surroundings until needed for use. The packaging film that will wrap the Fiber Swab Stick is proprietary as well in that it will separate the wet end from the dry end.

This product is used to clean fiber optic connectors and adapters. The connector, as used herein is, the male end which will “strike” like a match on the flat portion of the cloth wrapped stick to clean any contamination from the fiber end face. The adapter, as used herein, is the female part of the fiber connection that the swab portion of the stick will clean. The adapter is 2.5 mm in size therefore the swab portion of the fiber cleaning stick will be 2.5 mm.

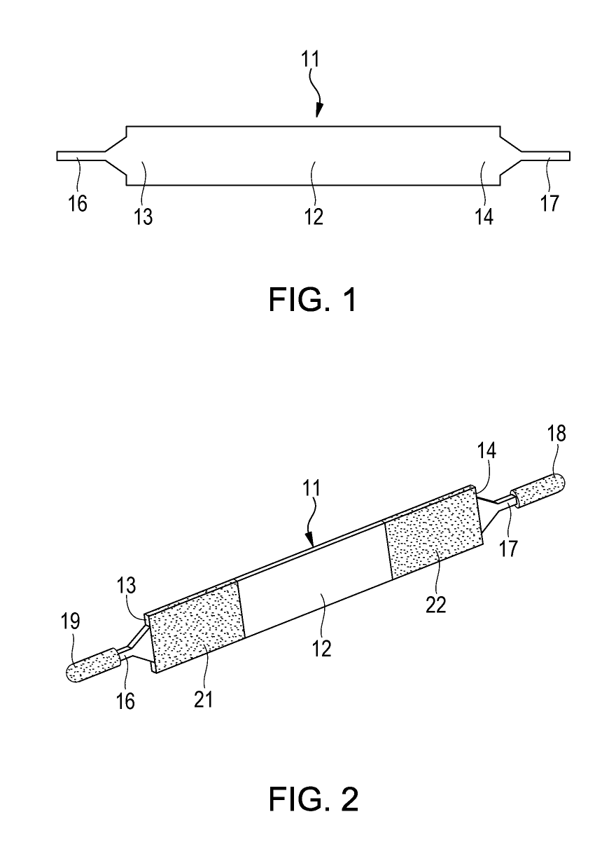

Referring to the Figures for a clearer understanding of the invention it may be seen in FIG. 1 and FIG. 2 that a first embodiment utilizes a base member 11 which is generally rectangular in shape and comprises a flat middle portion 12 with opposing ends 13 and 14 that taper to narrow probe-like ends 16 and 17. The base member is preferably a single layer of a resilient material such as a polymer or even a bio-degradable wooden product. The thickness of the base member 11 is approximately equal to the width of probe-like ends 16 and 17, which is slightly less than the 2.5 mm diameter of a typical fiber optic connection male end. When a swab of absorbent material is affixed to the probe-like ends to form swabs 18 and 19 the diameter of the swabs is suitable for insertion into the adapter such that the end of the swab can reach and clean the face of the optical fiber cable therein. In the embodiment of FIGS. 1 and 2 the absorbent material is wrapped around the flat middle of the base member 11 to form two discreet pad areas 21 and 22. These pad areas 21, 22 can be used to clean the male or connector end of the fiber optic connection.

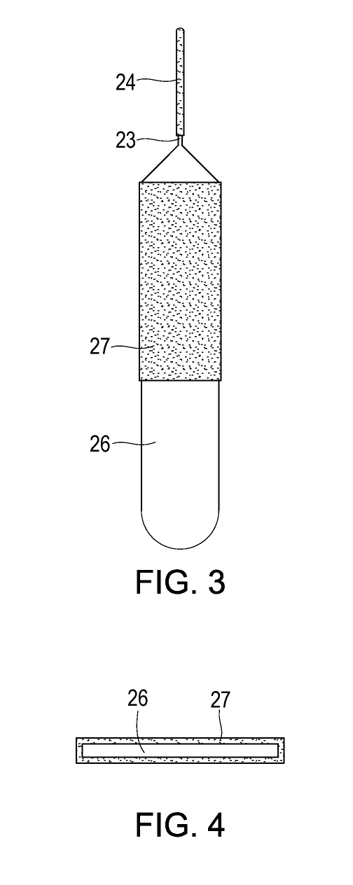

In FIGS. 3 and 4, a second embodiment is shown. This embodiment is dimensionally similar to the first embodiment in that probe-like end 23 is sized such that a swab 24 of absorbent material carried there on may be inserted into an adapter to clean the cable end therein. A single wrap of material about the flat wide mid-section 26 of the tool forms a cleaning pad 27. As noted the swab and cleaning pads may have a cleaning solvent applied lightly thereto.

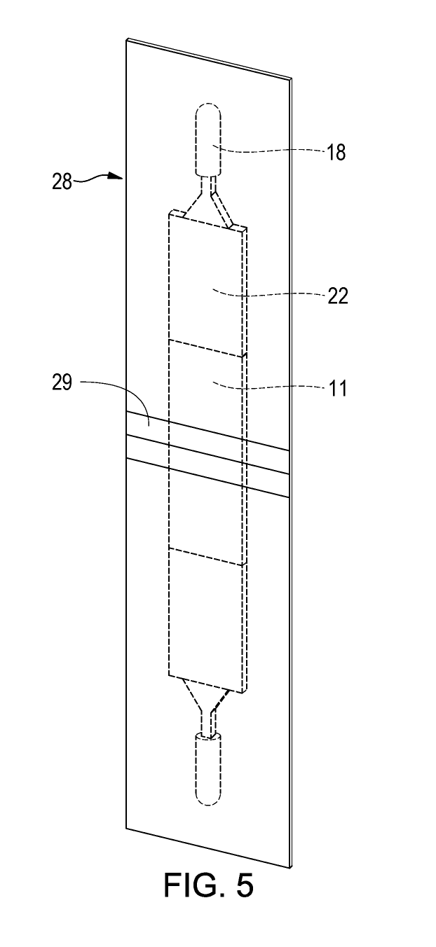

FIG. 5 illustrates the packaging of the first embodiment. In this figure, one end of the tool is dry and uncontaminated while the pad 22 and swab 18 on the other end carry a solvent. A frangible impermeable covering or bag 28 encases the tool and is sealed about the base member 11 intermediate the pads 21 and 22 at 29, such that the solvent cannot migrate and contaminate the dry end. The bag material will depend on the solvent used as the bag must withstand storage in intimate contact with the solvent for an extended period.

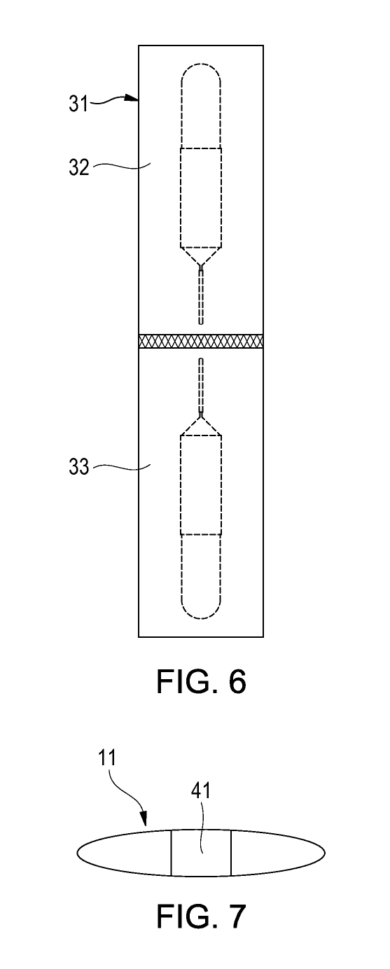

FIG. 6 illustrates the packaging of the second embodiment. In this embodiment the individual tools are packaged in a frangible impermeable bag 31 having two independent compartments 32 and 33. Each bag encloses a dry tool in one compartment and a “wet” tool in the other compartment. The bag can be easily sealed intermediate the tools to form the compartment and the packaging of the tools can easily be automated for this design. It is to be understood that although a wet and dry tool can be supplied, each of the embodiments may also be provided simply as a dry tool.

Referring to FIG. 7, note that the invention may also be provided with only the striking surfaces 41 such that the exposed ends of the fiber optic connection male end can be cleaned. This embodiment is less costly to manufacture and can be provided as a dry cleaner or a wet/dry cleaner.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A tool for cleaning the ends of fiber optic cables at a connection of two cable ends comprising:
a. A base member having a flat portion and a probe-like end, said flat portion and said probe-like end having a thickness no greater than the width of said probe-like end;
b. A swab of absorbent material affixed to said probe-like end and encompassing said end, said swab being suitably sized for insertion into an adaptor at a fiber optic cable connection to clean a fiber optic surface therewithin;
c. A pad of absorbent material affixed to said flat portion distal said probe-like end said pad being suitably sized and a configured for cleaning the fiber optic surface of a connector portion of a fiber optic cable connection.

2. A tool as defined in claim 1 further comprising a solvent dispersed on said pad of absorbent material.

3. A tool as defined in claim 2 further comprising a solvent dispersed on said swab.

4. A tool as defined in claim 1 further comprising a second probe-like end formed on said base member with a second swab of absorbent material affixed thereto and encompassing said second end and a second pad of absorbent material affixed to said flat portion intermediate said second probe-like end and said pad of absorbent material.

5. A tool as defined in claim 4 further comprising a solvent dispersed on said second swab.

6. A tool as defined in claim 5 further comprising a solvent dispersed on said second pad of absorbent material.

7. A tool as defined in claim 6 wherein said pad and said swab have no solvent applied thereto.

8. A tool as defined in claim 7 further comprising an impermeable frangible covering encasing said tool and segregating said pad and swab from said second pad and second swab.

9. A kit comprising a first tool as defined in claim 1 and a second tool as defined in claim 1, and a frangible covering enclosing said first and second tools in separate compartments.

10. A kit comprising a first tool as defined in claim 1 and a second tool as defined in claim 3, and a frangible impermeable covering enclosing said first and second tools in separate compartments.

11. A tool as defined in claim 1 wherein said base member is made from a single layer of resilient material.
